(19) United States
(12) Patent Application Publication
(10) Pub. No.: US 2007/0196641 A1
(43) Pub. Date: Aug. 23, 2007

(54) Production method of composite particles

(75) Inventors: Kouichi Ichiki, Ueda-shi (JP); Akihide Furukawa, Ueda-shi (JP)

Correspondence Address: BIRCH STEWART KOLASCH & BIRCH, PO BOX 747, FALLS CHURCH, VA, 22040-0747, US

(73) Assignee: Shinano Kenshi Kabushiki Kaisha, Nagano (JP)

(21) Appl. No.: 10/592,522

(22) PCT Filed: Feb. 6, 2006
(86) PCT No.: PCT/JP06/01981

§ 371 Date: Sep. 12, 2006

(30) Foreign Application Priority Data
Feb. 7, 2005 (JP) 2005-029950

(51) Int. Cl. B32B 5/22; B32B 5/16

(52) U.S. Cl. 428/323; 428/328; 428/317.9; 977/902

(57) ABSTRACT

There is provided a production method of composite particles, by which the fine composite particles which contain fine fibers in the particles, are spherical and have a particle size of 1 μm or less can be stably obtained. It is characterized in that when the composite particles containing fine fibers in the particles are produced, a water-soluble metal salt is dissolved in an aqueous solution in which the fine fibers have been dispersed, and that an alkali which reacts with a metal ion dissolved in the aqueous solution to deposit a metal compound is thereafter added to the aqueous solution while maintaining dispersion of the fine fibers, thereby depositing the composite particles containing the fine fibers and comprising the metal compound.

### TECHNICAL FIELD

The present invention relates to a production method of composite particles, and more particularly to a production method of composite particles containing fine fibers in the particles.

### Background Art

Fine fibers such as carbon nanotubes are high in its cohesive force and easily agglomerated, so that it is extremely difficult to directly add the fine fibers to a matrix and uniformly disperse them in the matrix.

Accordingly, the fine fibers can be uniformly dispersed in the matrix, for example, by forming composite particles containing the fine fibers in metal particles, adding these composite particles to the matrix, and uniformly dispersing them in the matrix.

Such composite particles can be obtained by a production method of composite particles proposed in the following patent document 1.

In such a production method, an electrolyte in which fine carbon fibers such as carbon nanotubes have been dispersed is electrolyzed to deposit metal particles in which the fine carbon fibers have been mixed on a cathode electrode, and then, the metal particles deposited are separated from the cathode electrode.

Patent Document 1: PCT International Publication WO2004/094700 Pamphlet

### DISCLOSURE OF THE INVENTION

According to the production method proposed in patent document 1, composite particles comprising metal particles in which fine carbon fibers have been uniformly dispersed can be obtained.

Meanwhile, as the composite particles comprising metal particles to be blended with a conductive paste, there have been desired composite particles comprising fine metal particles, which are spherical and have a particle size of 1 μm or less. This is because the conductive paste with which the composite particles comprising such fine metal particles are blended exhibits good fluidity and can homogenize a coated surface to which the conductive paste has been applied.

However, in an electrolytic process employed in the production method proposed in patent document 1, a metal tends to easily deposit on a cathode electrode in dendrite (arborescent) form. Accordingly, although it is possible to deposit the composite particles comprising spherical metal particles on the cathode electrode by adjustment of electrolysis conditions, the deposited composite particles comprising the spherical metal particles are liable to become coarse particles.

The tendency of such particle coarsening is also inhibitable by using the cathode electrode of niobium, titanium or the like, or by adding niobium to an electrolyte. However, it is still difficult to obtain the composite particles comprising metal particles, which are spherical and have a particle size of 1 μm or less.

Further, the concentration of an additive in the electrolyte and the like vary with the electrolytic time, so that it is difficult to control the form or particle size of the resulting composite particles comprising the metal particles.

It is therefore an object of the invention to provide a production method of composite particles, by which the fine composite particles which contain fine fibers in the particles, are spherical and have a particle size of 1 μm or less can be stably obtained.

The present inventors have made a series of studies for achieving the above-mentioned object, and have added an aqueous sodium hydroxide solution to an aqueous solution of copper sulfate in which carbon nanotubes are dispersed. As a result, particles comprising copper hydroxide containing the carbon nanotubes have precipitated. These precipitated particles have been reduced with a reducing agent. As a result, it has become clear that composite particles containing the carbon nanotubes, having a particle size of 1 μm or less and comprising spherical copper particles are obtained, thus completing the present invention.

That is to say, the present invention is a production method of composite particles, which is characterized in that when the composite particles containing fine fibers in the particles are produced, a water-soluble metal salt is dissolved in an aqueous solution in which the fine fibers have been dispersed, and that an alkali which reacts with a metal ion dissolved in the above-mentioned aqueous solution to deposit a metal compound is thereafter added to the above-mentioned aqueous solution while maintaining dispersion of the above-mentioned fine fibers, thereby depositing the composite particles containing the fine fibers and comprising the above-mentioned metal compound.

Further, the present invention is also a production method of composite particles, which is characterized in that when the composite particles containing fine fibers in the particles are produced, a water-soluble metal salt is dissolved in an aqueous solution in which the fine fibers have been dispersed, and that an alkali which reacts with a metal ion dissolved in the above-mentioned aqueous solution to deposit a metal compound is thereafter added to the above-mentioned aqueous solution while maintaining dispersion of the above-mentioned fine fibers, thereby depositing the composite particles containing the fine fibers and comprising the above-mentioned metal compound, followed by subjecting the above-mentioned deposited composite particles to reduction treatment with a reducing agent for reducing the metal compound, thereby obtaining the composite particles comprising the metal particles.

In such a present invention, the composite particles comprising the metal particles, which are subjected to the reduction treatment, can be stored without impairing the characteristics of the composite particles comprising the metal particles by protecting the particles with a protecting agent so that corrosion acceleration caused by the difference in potential between the metal which forms the above-mentioned metal particles and the fine fibers is inhibited to be able to keep a reduced state of the above-mentioned metal.

Further, in order to maintain dispersion of the fine fibers in the aqueous solution, shocks are given to the above-mentioned aqueous solution, thereby being able to easily disperse the fine fibers in the aqueous solution in the course of forming the composite particles. As the shocks given to the aqueous solution, ones due to an ultrasonic wave are preferred.

Furthermore, also when the alkali is added, the fine fibers can be easily uniformly dispersed in the aqueous solution by giving the shock to the aqueous solution. When the fine fibers are dispersed in the aqueous solution, a dispersing agent may be added to the aqueous solution.

As the fine fibers used in the present invention, there can be suitably used fine fibers having a diameter of 1 μm or less and a ratio of length to diameter (aspect ratio) of 2 or more, and as the water-soluble metal salt, there can be suitably used a water-soluble metal salt comprising copper, nickel or silver.

As such fine fibers, there can be suitably used carbon nanotubes.

### ADVANTAGE OF THE INVENTION

According to the present invention, the composite particles comprising the metal particles, which are deposited with the fine fibers contained, can be easily obtained.

Further, in the present invention, the composite particles comprising the metal particles can be obtained by subjecting the composite particles comprising the metal compound, which are deposited with the fine fibers contained, to the reduction treatment with the reducing agent.

Such composite particles obtained by the present invention can provide fine composite particles which are spherical, have a particle size of 1 μm or less, and have not been obtained by an electrolytic process employed in a conventional production method of the composite particles.

Moreover, in the present invention, the fine composite particles which are spherical and have a particle size of 1 μm or less can be stably obtained by controlling the amount of the fine fibers, the amount of the water-soluble metal salt and the amount of the additive for forming a slightly soluble metal salt or a slightly soluble metal oxide, added to the aqueous solution.

For this reason, the composite particles obtained by the present invention can be suitably incorporated, for example, in a conductive paste. The conductive paste in which these composite particles are incorporated exhibits good fluidity and can homogenize a coated surface.

### BRIEF DESCRIPTION OF THE DRAWINGS

FIG. 1 is an electron micrograph showing one example of composite particles comprising metal particles obtained by a production method relating to the present invention.

FIG. 2 is an electron micrograph showing another example of composite particles comprising metal particles obtained by a production method relating to the present invention.

FIG. 3 is a traced drawing in which an electron micrograph showing still another example of composite particles comprising metal particles obtained by a production method relating to the present invention has been traced.

### BEST MODE FOR CARRYING OUT THE INVENTION

In the present invention, the water-soluble metal salt is first dissolved in the aqueous solution in which the fine fibers have been dispersed. As such fine fibers, there can be used fine fibers having a diameter of 1 μm or less and a ratio of length to diameter (aspect ratio) of 2 or more. Specifically, they include fine carbon fibers such as carbon nanotubes and carbon nanofibers, fine silica fibers, fine titanium fibers and fine resin fibers.

Further, dispersion of such fine fibers can be performed by giving shocks due to an ultrasonic wave to the aqueous solution, or adding a dispersing agent while stirring the aqueous solution by mechanical stirring with a stirrer or the like. The dispersing agents include octylphenoxypolyethoxyethanol, sodium dodecylsulfate and polyacrylic acid as surfactants.

In order to perform more easily such dispersion of the fine fibers, it is preferred to give shocks due to an ultrasonic wave to the aqueous solution to which the above-mentioned dispersing agent has been added.

Further, as the water-soluble metal salt, there can be suitably used a water-soluble metal salt comprising copper, nickel or silver, and more preferably, there can be used a sulfate, a nitrate or an acetate comprising copper, nickel or silver.

When the water-soluble metal salt comprising copper, nickel or silver was used as such a water-soluble metal salt, a hydroxide of copper or nickel, or an oxide of silver is deposited by the reaction with an alkali.

Then, the alkali which reacts with a metal ion dissolved in the aqueous solution to deposit the metal compound is added to the aqueous solution while maintaining dispersion of the fine fibers.

Such a metal compound deposited by adding the alkali forms fine composite particles while incorporating therein the fine fibers dispersed in the aqueous solution. Accordingly, also when the deposited composite particles comprising the metal compound are formed, dispersion of the fine fibers in the aqueous solution is maintained, and fine composite particles which are deposited in the aqueous solution and in the course of formation are allowed to be dispersed in the aqueous solution, thereby being able to obtain the composite particles in which the fine fibers are uniformly dispersed.

Such dispersion of the fine fibers and the fine composite particles in the course of formation in the aqueous solution is possible by giving shocks to this aqueous solution. The shocks can also be given by stirring the aqueous solution by mechanical stirring with a stirrer or the like. In particular, it is preferred that the shocks due to an ultrasonic wave are given to the aqueous solution in which the dispersing agent has been added.

The alkalis used herein include sodium hydroxide, potassium hydroxide and calcium hydroxide.

Further, in order to prevent the coagulation of the deposited fine composite particles comprising the metal compound, a surfactant may be added to the aqueous solution.

The thus-deposited fine composite particles comprising the metal compound are composite particles which are substantially spherical, and contain the fine fibers having a particle size of 1 μm or less.

Further, such composite particles are formed in the aqueous solution in which the fine fibers have been dispersed, and the fine fibers dispersed in the aqueous solution can be incorporated in the composite particles in the course of forming the composite particles. The fine fibers are contained in the composite particles formed, in a uniformly dispersed state.

Such composite particles are separated from the aqueous solution, and easily uniformly blended with a conductive paste or the like. The fine fibers contained in the composite particles can also be uniformly dispersed in a matrix.

In addition, the composite particles may be blended with the conductive paste or the like in a colloidal state without being separated from the aqueous solution.

Meanwhile, composite particles comprising metal particles, which are more improved in characteristics such as conductive characteristics than the composite particles comprising the metal compound, can be obtained by subjecting the resulting composite particles to reduction treatment with a reducing agent for reducing the metal compound.

As such a reducing agent, there can be used one or two or more kinds of the group consisting of hydrazine, a hydrazine compound, formalin, acetaldehyde, formic acid, Rochelle salt, hydroxylamine, glucose and hydrogen peroxide. This reducing agent may be added to the aqueous solution in which the deposited composite particles comprising the metal compound are precipitated, or may be brought into direct contact with the composite particles comprising the metal compound, which has been separated from the aqueous solution, thereby reducing the metal compound. Thus-obtained composite particles comprising the metal particles, which are subjected to the reduction treatment, are composite particles comprising the metal and the fine fibers, so that when the potential of the metal is baser than the potential of the fine fibers, there is the possibility of corrosion such as oxidation or sulfuration of the metal being accelerated by contact with the aqueous solution or the air, compared with particles formed by the metal element. Accordingly, the composite particles comprising the metal particles can be protected in a state in which the reduction treatment has been performed, by protecting the composite particles with a protecting agent so as to be able to maintain the reduced state of the metal.

Further, when foaming occurs by the reduction treatment with the reducing agent added to the aqueous solution, or by the surfactant added, a defoaming agent such as an alcohol may be added.

The resulting composite particles comprising the metal particles can be used as materials such as powder metallurgy, batteries, chemicals, electromagnetic shields, conductive materials, metal bonds for thermal conductive material, friction material contacts, resin fillers and sliding materials, as well as conductive pastes.

### EXAMPLE 1

Multilayer carbon nanotubes (0.21 g) having a diameter of several nanometers as fine fibers, 132 g of purified water and 0.5 g of octylphenoxypolyethoxyethanol [trade name: TORITON X-100 (manufactured by INC Biomedical, Inc.)] as a surfactant were subjected to dispersion treatment by an ultrasonic homogenizer (VC-750 manufactured by Ultra Sonic, Inc.), and then, 28 g of copper sulfate pentahydrate (CuSO₄.5H₂O) was put therein, followed by stirring with a stirrer to obtain a dispersion.

Further, there were prepared an alkali solution in which 9 g of sodium hydroxide (NaOH) was added to 102 g of purified water, and a reducing agent solution in which 12 g of hydrazine monohydrate (N₂H₄.H₂O) was added to 133 g of purified water.

Then, the alkali solution was added to the resulting dispersion while giving an ultrasonic wave with an ultrasonic washer (US-1 manufactured by as One Co., Ltd.) and stirring with a glass rod. The dispersion became a deposition solution in which composite particles comprising hydroxide of copper were deposited.

To this deposition solution, 50 g of ethanol as a defoaming agent was added, and 1.8 g of a corrosion inhibitor (Cu—K manufactured by Yuka Sangyo Co., Ltd.) as a protecting agent for the composite particles comprising the metal particles was added, followed by heating up to 60° C.

Further, the reducing agent solution was added with stirring the deposition solution heated to perform a reduction reaction. In that case, 50 g of ethanol was further added depending on the situation of foaming to terminate the reduction reaction. After the reduction reaction was terminated, the deposition solution was cooled to ordinary temperature, and a precipitate was collected, followed by washing and drying under vacuum.

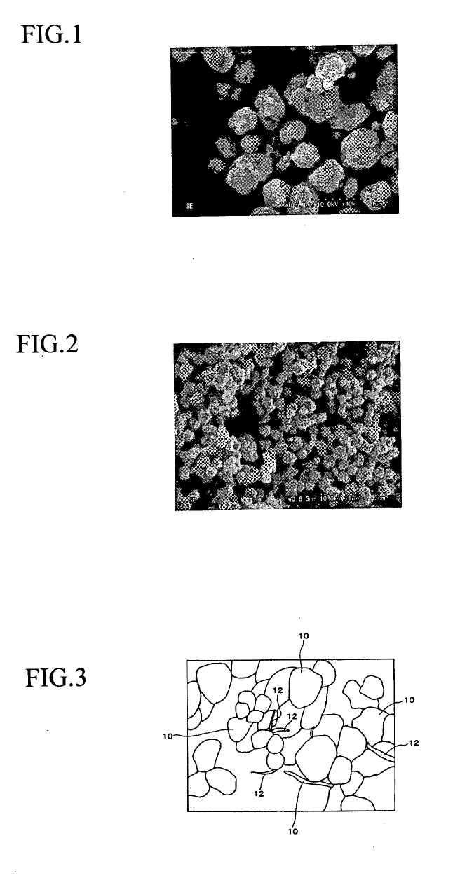

The resulting composite particles comprising the metal particles showed a copper color, and when observed under an electron microscope (×40000 magnification), they were spherical and had a particle size of 1 μm or less, as shown in FIG. 1.

### EXAMPLE 2

Multilayer carbon nanotubes (0.18 g) having a diameter of several nanometers as fine fibers, 100 g of purified water and 0.4 g of octylphenoxypolyethoxyethanol [trade name: TORITON X-100 (manufactured by INC Biomedical, Inc.)] as a surfactant were subjected to dispersion treatment by an ultrasonic homogenizer (VC-750 manufactured by Ultra Sonic, Inc.), and then, 28 g of nickel chloride (NiCl₂) was put therein, followed by heating up to 50° C. while stirring with a stirrer to obtain a dispersion.

Further, there was prepared an alkali solution in which 13 g of sodium hydroxide (NaOH) was added to 50 g of purified water.

Then, the alkali solution was added to the resulting dispersion while giving an ultrasonic wave with an ultrasonic washer (US-1 manufactured by as One Co., Ltd.) and stirring with a glass rod. The dispersion became a deposition solution in which composite particles comprising hydroxide of nickel were deposited.

Hydrazine monohydrate (N₂H₄.H₂O) (64 g) was added as a reducing agent while heating this deposition solution up to 60° C. and stirring with a stirrer to perform a reduction reaction. In that case, 100 g of ethanol was added depending on the situation of foaming to terminate the reduction reaction. After the reduction reaction was terminated, the deposition solution was cooled to ordinary temperature, and a precipitate was collected, followed by washing and drying under vacuum.

The resulting composite particles comprising the metal particles showed a nickel color, and when observed under an electron microscope (×18000 magnification), they were spherical and had a particle size of 1 μm or less, as shown in FIG. 2.

Further, a traced drawing in which an electron micrograph of these composite particles taken at ×45000 magnification has been traced is shown FIG. 3. Respective end portions of multilayer carbon nanotubes 12, 12•• are incorporated in metal particles 10.

Furthermore, the resulting composite particles comprising the metal particles were immersed in diluted nitric acid to dissolve nickel forming the composite particles, and then, this nickel-dissolved solution was filtered through a membrane filter. As a result, the multilayer carbon nanotubes remained on the membrane filter. The multilayer carbon nanotubes were dried, and the weight thereof was measured. As a result, the weight of the multilayer carbon nanotubes contained in the resulting composite particles was 2.7% by weight.

As apparent from this dissolution experiment and FIG. 3, it is proved that the multilayer carbon nanotubes are contained in the metal particles.

### EXAMPLE 3

Multilayer carbon nanotubes (0.05 g) having a diameter of several nanometers as fine fibers, 100 g of purified water and polyacrylic acid (molecular weight: 5000) as a surfactant were added and subjected to dispersion treatment by an ultrasonic homogenizer (VC-750 manufactured by Ultra Sonic, Inc.), and then, 10 g of silver nitrate (AgNO₃) was put therein to obtain a dispersion.

Further, there was prepared an alkali solution in which 3.2 g of sodium hydroxide (NaOH) was added to 50 g of purified water.

Then, the alkali solution was added to the resulting dispersion while giving an ultrasonic wave with an ultrasonic washer (US-1 manufactured by as One Co., Ltd.) and stirring with a glass rod. The dispersion became a deposition solution in which composite particles comprising dark brown silver oxide particles were deposited.

A precipitate was collected from this deposition solution, followed by washing and drying under vacuum. The resulting composite particles showed a dark brown color, and there were obtained spherical composite particles comprising silver oxide, which have a particle size of 1 μm or less, when observed under an electron microscope.

### EXAMPLE 4

Multilayer carbon nanotubes (0.05 g) having a diameter of several nanometers as fine fibers, 100 g of purified water and polyacrylic acid (molecular weight: 5000) as a surfactant were added and subjected to dispersion treatment by an ultrasonic homogenizer (VC-750 manufactured by Ultra Sonic, Inc.), and then, 10 g of silver nitrate (AgNO₃) was put therein to obtain a dispersion.

Further, there were prepared an alkali solution in which 3.2 g of sodium hydroxide (NaOH) was added to 50 g of purified water, and a reducing agent solution in which 10 g of hydrazine monohydrate (N₂H₄.H₂O) was added to 50 g of purified water.

Then, the alkali solution was added to the resulting dispersion while giving an ultrasonic wave with an ultrasonic washer (US-1 manufactured by as One Co., Ltd.) and stirring with a glass rod. The dispersion became a deposition solution in which composite particles comprising silver oxide were deposited.

To this deposition solution, a discoloration preventing agent (AG-10 manufactured by World Metal Co., Ltd.) as a protecting agent for silver was added, and then, the reducing agent solution was added with stirring the deposition solution to perform a reduction reaction. After the reduction reaction was terminated, a precipitate was collected, followed by washing and drying under vacuum.

The resulting composite particles comprising the metal particles showed a silver color, and when observed under an electron microscope, they were spherical and had a particle size of 1 μm or less.

What is claimed is:

1. A production method of composite particles, which is characterized in that when the composite particles containing fine fibers in the particles are produced, a water-soluble metal salt is dissolved in an aqueous solution in which said fine fibers have been dispersed, and that an alkali which reacts with a metal ion dissolved in said aqueous solution to deposit a metal compound is thereafter added to said aqueous solution while maintaining dispersion of said fine fibers, thereby depositing the composite particles containing the fine fibers and comprising said metal compound.

2. The production method of composite particles according to claim 1, wherein shocks are given for maintaining the dispersion of the fine fibers in the aqueous solution.

3. The production method of composite particles according to claim 2, wherein the shocks given to the aqueous solution are given by an ultrasonic wave.

4. The production method of composite particles according to claim 1, wherein fine fibers having a diameter of 1 μm or less and a ratio of length to diameter (aspect ratio) of 2 or more are used as the fine fibers.

5. The production method of composite particles according to claim 1, wherein a water-soluble metal salt comprising copper, nickel or silver is used as the water-soluble metal salt.

6. The production method of composite particles according to claim 1, wherein carbon nanotubes are used as the fine fibers.

7. A production method of composite particles, which is characterized in that when the composite particles containing fine fibers in the particles are produced, a water-soluble metal salt is dissolved in an aqueous solution in which the fine fibers have been dispersed, and that an alkali which reacts with a metal ion dissolved in said aqueous solution to deposit a metal compound is thereafter added to said aqueous solution while maintaining dispersion of said fine fibers, thereby depositing the composite particles containing the fine fibers and comprising the above-mentioned metal compound, followed by subjecting said deposited composite particles to reduction treatment with a reducing agent for reducing the metal compound, thereby obtaining the composite particles comprising the metal particles.

8. The production method of composite particles according to claim 7, wherein the composite particles comprising the metal particles are protected with a protecting agent so that corrosion acceleration caused by the difference in potential between the metal which forms the above-mentioned metal particles and the fine fibers is inhibited to be able to keep a reduced state of the above-mentioned metal.

9. The production method of composite particles according to claim 7, wherein shocks are given for maintaining the dispersion of the fine fibers in the aqueous solution.

10. The production method of composite particles according to claim 9, wherein the shocks given to the aqueous solution are given by an ultrasonic wave.

11. The production method of composite particles according to claim 7, wherein fine fibers having a diameter of 1 μm or less and a ratio of length to diameter (aspect ratio) of 2 or more are used as the fine fibers.

12. The production method of composite particles according to claim 7, wherein a water-soluble metal salt comprising copper, nickel or silver is used as the water-soluble metal salt.

13. The production method of composite particles according to claim 7, wherein carbon nanotubes are used as the fine fibers.
